(19) United States
(12) Patent Application Publication
(10) Pub. No.: US 2001/0053949 A1
(43) Pub. Date: Dec. 20, 2001

(54) Secure tracking of articles

(75) Inventors: Curtis W. Howes, Harvard, MA (US); C. Deniz Akyuz, Somerville, MA (US); Brian A. Arthur, East Greenwich, RI (US); Richard G. Ouellette, Canton, MA (US); Howard Stern, Greenlawn, NY (US)

Correspondence Address: Morris I. Pollack, 19 Eberhardt Road, East Hanover, NJ, 07936, US

(73) Assignee: Robotic Vision Systems, Inc.

(21) Appl. No.: 09/804,811

(22) Filed: Mar. 13, 2001

Related U.S. Application Data
(60) Provisional application No. 60/188,678, filed on Mar. 13, 2000.

(51) Int. Cl. G06F 17/00

(52) U.S. Cl. 700/237; 707/104.1; 707/9; 700/215; 700/225; 705/28

(57) ABSTRACT

A secure tracking system and method of tracking for articles which are secure and include authentication and verification of users and user devices for data and information access and input. Each article to be tracked is provided with a unique secure indicia applied to the article and through which chronological histories are generated and maintained from creation of each article until at least the time when article is scrapped or otherwise destroyed. The articles can include manufactured components, assemblies, device and equipment for aircraft, automotive, military and other users, as well as jewelry and works of art.

### CROSS-REFERENCE TO RELATED APPLICATIONS

This application claims the benefit of prior-filed and co-pending Provisional Patent Application No. 60/188,678 filed on Mar. 13, 2000 for “Secure Tracking Of Manufactured Components”.

### BACKGROUND OF THE INVENTION

1. Field of Use

This invention relates to tracking of articles; and more particularly to the tracking of articles for purposes relating to the history of the articles, such as availability, use, ownership, location and the like.

2. Description of the Prior Art

The history of events for articles such as their creation, availability, use authenticity, possession and ownership have always been of importance, especially to the parties that are using and/or that own such articles. Articles such as jewelry and works of art may be stolen and/or replaced by fake reproductions. Articles such as automobiles parts may be offered, paid for and expected to perform as new or remanufactured, but instead may be of bogus origin, overpriced and may not perform as expected. Similarly, component parts, sub-assemblies and assemblies for the aircraft industry may also be fake or used parts sold as new or refurbished or even new parts sold for unapproved purposes all of which may increase downtime, maintenance or result in crash of the plane with possible loss of life and the grief and costs resulting from such failures of performance.

Efforts to track and authenticate articles and their ownership appear to have been conceived. Systems such as that suggested in U.S. Pat. No. 5,124,935, dated Jun. 23, 1992 for “Gemstone Identification, Tracking and Recovery System”, however, utilize images of laser light reflected off each gemstone as the identifier for the gemstone. The images are electronically stored in a database along with ownership and insurance information with the database being accessible by jewelers, police and the like for direct data entry. Such images or even images of gemstone characteristics obtained by light passing through the gemstone may be easily altered by re-cutting the gemstone, thus defeating the ability to track the gemstone. More importantly, access to such systems appears to be available to anyone with a system user name and password with no further verification. An alternative article identification system is shown and described in U.S. Pat. No. 5,379,102 patented on Jan. 3, 1995 for “System For Identifying Jewels”. This system, however, requires determination and storage of four distinctly different characteristics of each jewel and highly complex and expensive equipment for doing so. Here again access to all jewel information in the database is available to any party with a system user name and password without further verification.

Other database systems have been suggested for marking and tracking articles. U.S. Pat. No. 4,893,840, patented on Jan. 16, 1990 for “Article Identification Label And Method Of Article Identification” utilizes customer identification codes on a label affixed to the temple piece of eyeglasses and a central clearinghouse available to all callers to locate the owner of the article. While U.S. Pat. No. 4,749,847, patented on Jan. 7, 1988 for “Method And Device For Identifying A Valuable Object” requires a notched identifying cylinder to be inserted into an article. Many articles are relatively small or not otherwise able to have such an identifier inserted. Identifiers so inserted may also be removable and replaced, thus defeating their purpose.

U.S. Pat. No. 5,983,238, patented on Nov. 9, 1999 for “Gemstones Identification Tracking And Recovery System” describes applying a number to each gemstone to identify the article and correlating that article number into a database along with information about the gemstone including ownership and whether the article is lost or stolen. Access to the described system and its' database is described as requiring a user name and password but in many respects is otherwise not secure.

Tracking systems also exist for tracking articles that may be letters, packages or the like. Such systems are provided by organizations such as Federal Express, United Parcel Service and even the United States Postal Service. However, those systems are generally available and open to the public and knowledge of the number carried by the article label, or by guessing of a comparable arrangement of numbers and/or letters, is all that is required to access the system tracking database.

U.S. Pat. No. 4,558,318 patented on Dec. 10, 1985 and U.S. Pat. No. 4,816,824 patented on Mar. 28, 1989 respectively are both for Merchandise Verification And Information Systems. However, each unit of merchandise is only to be tracked from manufacture to sale to a customer and thereafter the tracking of the product and its history ceases. The system, furthermore, provides for access to its central processor and memory by a number of terminals which are not described as secure. Only the management terminal is alluded to as secure without any description of what its secure from or how its security is accomplished. On the other hand U.S. Pat. No. 5,491,637 patented on Feb. 13, 1996 and U.S. Pat. No. 5,621,647 patented on Apr. 15, 1997, both for “Method Of Creating A Comprehensive Manufacturing, Shipping And Location History For Pipe Joints” not only do not provide a history following use of the pipe joints but, in fact, require removal of the unique joint number once the joints are so used.

There are also aircraft industry related databases such as that shown and described in U.S. Pat. No. 5,778,381 patented Jul. 7, 1998 for “Computer Aided Maintenance And Repair Information System For Equipment Subject To Regulatory Compliance”, however, that system is for complex technical information employed to maintain and repair complicated equipment and is not directed to the parts, subassemblies, assemblies, etc. and the specific equipment into which such are installed.

### SUMMARY OF THE INVENTION

It is therefore an object of this invention to provide new and novel systems for the secure tracking of articles.

It is another object of this invention to provide new and novel systems for the secure tracking of parts, components, subassemblies, assemblies and entire articles of manufacture.

It is yet another object of this invention to provide new and novel systems for articles of manufacture and components thereof, which enable tracking of same from their creation until use thereof is concluded.

It is yet still a further object of this invention to provide new and novel article identification and tracking in a highly secure manner.

It is yet still a further object of this invention to provide new and novel article identification which provides for each article, and component parts thereof, a unique and secure identifier.

It is yet still a further object of this invention to provide new and novel article tracking systems which authenticate and verify parties and equipment having access thereto.

It is yet still a further object of this invention to provide new and novel article tracking systems which correlate the intended propriety of use of an article being tracked.

It is yet still another object of this invention to provide new and novel article tracking systems which generate and maintain chronological histories of articles being tracked from creation of such articles until use thereof is concluded.

It is yet still another object of this invention to provide new and novel article tracking systems which generate and maintain chronological histories of articles being tracked as well as of the devices a nd mechanisms which include such articles and of equipment which utilize and/or incorporate such devices and mechanisms.

It is yet still a further object of this invention to provide new and novel secure article identification and tracking for jewelry.

It is yet still a further object of this invention to provide a new and novel secure article identification and tracking for component parts, subassemblies, assemblies and the like for military articles, vehicles and mobile equipment.

It is yet still a further object of this invention to provide new and novel secure article identification and tracking for component parts, subassemblies, assemblies and the like for automobile vehicles, especially replacement parts therefore.

It is yet still a further object of this invention to provide new and novel secure article identification and tracking for component parts, subassemblies, assemblies and the like for the aircraft industry; especially for line replaceable parts for same.

It is yet still another object of this invention to provide new and novel secure article identification and tracking for articles such as components, subassemblies, assemblies and the like from the manufacture of same through combinations thereof, placement is local or remote inventory, movement to and storage by users thereof, use as replacements or in rebuilding and the discarding of same.

The system is to be applied to the smallest component parts of an article such as an item of manufacture; and is to be applied to sub-assemblies, assemblies and possibly the final assembled article which includes such component parts.

The system requires that each such component part carry a unique part identifier in an encoded symbology (preferably a 2-D symbology such as a DATAMATRIX of the type described and shown in U.S. Pat. No. 5,984,366 patented on Nov. 16, 1999 for “Unalterable Self-Verifying Articles”) preferably marked directly to the component part; (but which might be otherwise applied as by application to a media which is, in turn, applied to the part in a manner highly resistive to removal). The unique part identifier may also include a part security code which may be obtained from a security entity and may also include a part code assigned by the part manufacturer; other unique part identifiers may be utilized. The encoded symbology may also and preferably does include a part number and/or a serial number within the part code (the part number is usually identical for identical parts because industry today identifies its parts for ordering, maintenance and other purposes by a part number which is usually the part drawing number; a serial number my also be assigned by the manufacturer to facilitate such purposes). The part code may include other data peculiar to the manufacture of the part such as manufacturing facility name or location, identity of machine(s) utilized to manufacture the part, whether the part was inspected or not, conformity of the part to specification and/or tolerances, etc.; whether this type of data is, or is not, provided within the part code, it may instead (or also) be stored in the security entities central, accessible, database and keyed to the unique part identifier.

The unique part identifier encoded symbology will most definitely include, and/or be encrypted with, a security code, assigned by and derived from the security entity, which may be peculiar to the particular part or part manufacturer. The unique part identifier encoded symbology is preferably to be machine-readable symbology and not human readable symbology. It might include alpha numerics. It might be placed upon the part so as to not be visible to the human eye [such as by being under paint or by being in a media invisible to the human eye]. Such encoded symbology may be accessed [read] by the use of X-rays, ultrasonics, magnetics, ultra violet light and/or a conventional imager; and then decoded when and if necessary. The security entity is to store, in a secure manner, each and every unique part identifier. As each part is relocated; such as for a manufactured component which moves from manufacture to each storage location, each shipment, each inventory disposition, each use, each rework, each recertification and final disposal, the security entity is to be contacted and the parts current disposition recorded [with the record of prior dispositions maintained]. The security entity, when contacted over the internet (preferably), uses a secure means of transmission that authenticates the client transmitting the information and the security entity response.

All contact is to be by persons and through equipment, authorized to contact the security entity [per trusted third party computer verification], or changes in the disposition of the part will not be accepted into the system. Entry to the System to enter data or obtain data may require use of a “private key” or a combination of a “private key” and a “public key”; or other similar secure entry and access identification.

The security entity will preferably provide History Of Part movements and use [and of persons reporting such activity] only to authorized and designated parties. The validity of a part will be governed by the unbroken chain of ownership as the part moves from the factory where produced into a subassembly and assembly, thence perhaps into a repair shop and again into a new subassembly, etc.

Other objects, features, and advantages of the inventions in their systems and methods and details of arrangement will be seen from the above, from the following description of the preferred embodiments when considered with the drawings and from the appended claims.

### BRIEF DESCRIPTION OF THE DRAWING

In the drawing:

FIG. 1 is a schematic showing the inter-relationship between the Secure Article Tracking System Provider and a System Subscriber to the Secure Article Tracking System so provided;

FIG. 2 is a schematic showing obtaining of a unique part identifier by the subscriber of FIG. 1;

FIG. 3 is a schematic showing a subscriber, such as that of FIG. 1, accessing the Secure Article Tracking System to enter article transfer data;

FIG. 4 is a schematic showing a subscriber, such as that of FIG. 1, querying the Secure Article Tracking System for traceability and possible indemnification;

FIG. 5 is a graphic representation of a program screen of the tracking system as it might appear during an authentication request to the tracking system;

FIG. 6 is a graphic representation of a program screen of the tracking system as it might appear during a part history request to the tracking system; and

FIG. 7 is a graphic representation of a program screen of the tracking system as it might appear during a part availability request to the tracking system.

### BRIEF DESCRIPTION OF THE PREFERRED EMBODIMENTS

With reference to FIG. 1 there is generally shown, in schematic, a secure article tracking system 20, incorporating the instant invention, and which is to be made available by a system provider 22 to system subscribers 24. System 20 is assembled by system provider 22 so as to include and/or utilizes a data services component 26, a data warehouse component 28, an internet service provider 30 (ISP) with a virtual private network and a trusted security component 32.

Data services component 26 is to include readily available conventional databases and computer controlled programs for providing security, data warehousing, transaction accounting and reports for tracking system 20. Data warehouse component 28 is to include, for tracking system 20, conventionally available facilities to securely receive, store and make available large, even massive, quantities of data; as well as readily available conventional related industry databases and computer programs for receiving, storing and transmitting data associated with the type and specific character of the article or articles chronological history for the industry to which the article(s) pertain. Thus for articles used in automobile manufacture the conventional related industry databases might include information on automobile manufacture; while for the aircraft industry such databases might include engine, wheel assembly and aircraft movement information and similar data. An available ISP 30, with a virtual private network or networks, is associated with and utilized by tracking system 20. Trusted security component 32 is preferably provided by a third party company recognized as providing trusted third party verification of parties having access to a particular system such as tracking system 20.

Subscriber 24 is but one of many possible subscribers to system 20 all of which desire to be able to securely track the chronological history of articles that they are concerned about, from the creation of such articles and until the articles are no longer of use and are scrapped or otherwise destroyed. System 20 is of significant use for articles of manufacture such as component parts, subassemblies, assemblies and the like; as well as for the devices and/or mechanisms that utilize or otherwise incorporate such articles and the equipment that, utilizes such devices and mechanisms. The article(s) to be tracked could be, by way of example, a compressor blade to be built into a mechanism such as an aircraft engine to be incorporated into equipment such as an airplane. Thus there are many different kinds and types of manufactured articles and many different kinds and types of assembled devices and mechanisms for which system 20 may be used to securely track the history of use and application. System 20 also, through its databases, correlates the particular article to a particular device or mechanism and provides an indication that the article is not the correct article for the particular device or mechanism thus providing a safety feature against incorrect assembly. System 20 may be utilized, similarly, for the automotive industry and for military equipment and vehicles. It also has application for tracking jewelry and works of art.

Subscriber 24 may, by way of example, be: a manufacturer of one or more articles to be tracked; a manufacturer of goods such as automobile or aircraft that wishes to, or is required to, track the manufactured articles that make up the final assembled goods; an article supplier; a repair facility; or an agency or organization that oversees the status (safety, use, repair history, etc.) of such goods; or the like. Alternatively subscriber 24 may be a jeweler intent on tracking and authenticating items of jewelry; or the insurer of jewelry, or the police, all interested in finding and recovering lost and stolen items of jewelry. Dealers and collectors of works of art, as well as museums, also have an interest in secure tracking of such article and could utilize a system 20 customized to their particular articles.

System 20 is capable of serving many subscribers and of receiving, warehousing, searching and outputting data for extremely large, even massive, numbers of articles.

Each subscriber 24 is to obtain, at the time of registration as a subscriber, at least one subscriber user name and password or pass code combination. If preferred, optional secure identification, smartcard and smartcard authentication system can be used to increase security. The server and/or computer to be used by the subscriber are also provided with a secure identification. Business rules, to be hereinafter described in greater detail are also established by contract between subscriber 24 and system provider 22 so that each subscriber 24 knows and can only access, modify, trace or otherwise utilize tracking system 20 for purposes pertinent to that subscriber. It should be understood that each subscriber may employ, rely upon, or contract with a number of people and/or utilize a number of servers and computers to access and use system 20 each such person, server and computer may also be provided with unique identification within the scope of the subscriber and for reasons to be hereinafter described in greater detail.

In order to provide a most secure system for tracking articles, system 20 incorporates, utilizes and initiates industry standard highest ISP for each communication between system subscriber 24 and system 20 whenever subscriber 24 logs in to system 20. Subscriber 24 as used in this description includes one or more individuals that may be employed directly or indirectly by subscriber 24, as well as third parties as long as such have been authorized by subscriber 24 and provided with authentication identification registered with system 20. For each communication between subscriber 24 and tracking system 20 there is a login request which is processed as follows:

all information is encrypted;

trusted security component 32 authenticates the subscriber, the subscriber server being used and, if desired, the server for system 20;

the subscriber users computer is authenticated by the subscribers server and/or digital signatures; and

the subscriber user is authenticated with user name and pass code combination. Optional secure identification, smartcard, and smartcard authentication systems can be used to increase security if so desired.

The subscriber, through its authorized user, after a login request, sends a further request to system 20, which processes that request. In doing so, system 20 (following authentication of the user as described above): decodes the request message; requests information necessary for further processing from appropriate database servers in distributed database systems incorporated into system 20 or otherwise associated therewith. The data exchange between the database servers and other components of system 20 conforms to business rules assigned to the request type and business agreements between subscriber 24 and system provider 22 and if utilized third parties that may host and/or own the data.

System 20 thereafter takes all necessary actions for the process, builds a reply message in an appropriate document. System 20 then uses the users computer and browser type information to build a proper output document in appropriate language and format and then streams the output to the subscriber user.

Each request initiates a series of processes in the system 20 and then subsequently in its database system. Requests from subscribers/users can be divided into major groups depending on what they pertain to and the required type of processing (active vs. passive).

For example, for a system 20 for tracking parts, particularly for the aircraft industry, such requests may be as set out in the following Sample List Of Requests:

### Sample List of Requests

1. logon request

2. specific part tracking request by unique id number

a. passive

i. authentication

current status

current location

company

station

section

ii. reports

part history

part maintenance

current known configuration of the part

iii. search

find replacement parts (with the same part number) for given criteria:

in certain locations

belong to specific companies

available usage

b. active

i. action

register

manufacture

mark

store

ship

receive

pack

unpack

install

remove

modify

repair

overhaul

scrap

ii. set status

actions set automatically

manufactured

usable

installed

packed

shipped

received

to be repaired

to be overhauled

to be scrapped

scrapped

iii. log

usage

hours of operation

number of landings

text notes

certificates

registration

marking

c. automatic (system)

i. flags are set automatically based on the part status and history as a consequence of each active request

suspect

available

workable

3. generic part inquiry request by part number

a. passive

i. reports

find parts with certain failing criteria

number of repairs

repair level

number of overhauls

ii. search

find parts for given criteria:

in certain locations

belong to specific companies

available usage

4. user management request

a. passive

i. authentication

registration information

current status

available usage

ii. reports

b. active

i. add new user

ii. change user

activate

deactivate

terminate

permissions

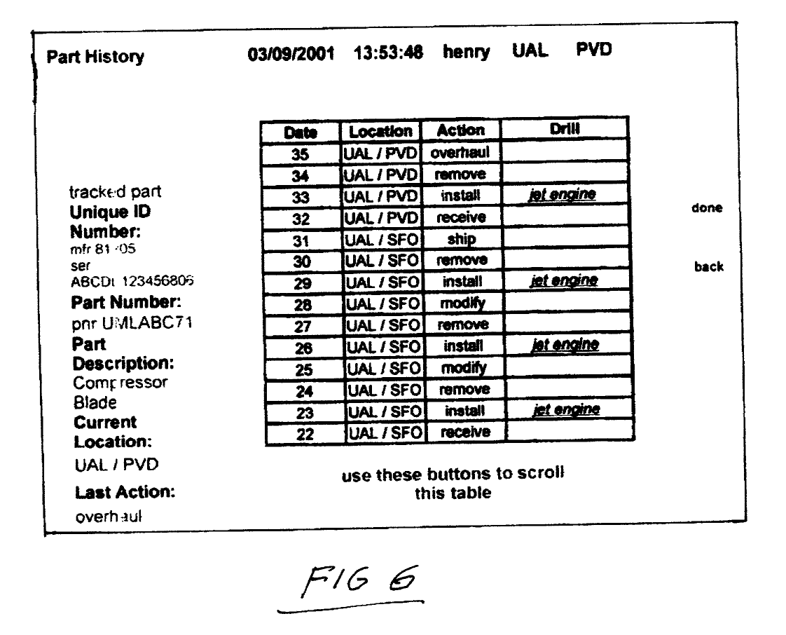

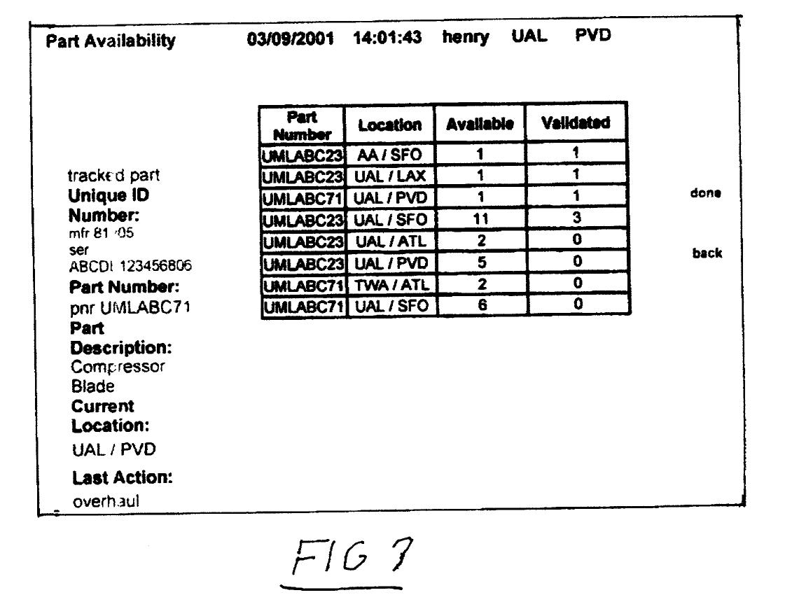

With each such request appropriate indications are provided to the user, by way of screen displays, such as windows and drop down windows such as those shown, by way of example in FIGS. 5, 6 and 7, so that the user obtains responses and is prompted in interacting with system 20 during the processing of requests by system 20. Links are also provided to the user to initiate requests pertaining to the chronological history of devices and/or mechanisms (such as an engine for a part that is a compressor blade) into which the part has been incorporated and/or the equipment (such as an airplane) powered by that engine.

As previously mentioned business rules determine if a certain request is allowed. The business rules depend on the current part status, location, owner, user permissions, and the specific request. For example, a receiver cannot receive a part unless that part has not been shipped out from its last location. Such a conflicting request will flag the user and the management and must be resolved before another action can be requested on the specific part. The following list includes a sample set of requests with the corresponding set of business rules, that might be agreed upon be a subscriber 24 and system provider 22 for a system 20 for tracking airplane parts:

### List of Sample Requests and Corresponding Business Rules

0. subscriber/user verified system 20 server through digital certificates and third party verifiers.

1. establish connection with system 20 part tracking server

subscriber/user server and/or computer must be authenticated by certificates an/or third parties.

2. logon to system 20 database

user must be authenticated for the specific (authenticated) location.

3. get part authentication

user must have permission to request part authentication information.

subscriber 24 where the user is must have the proper business agreements to request part authentication.

4. current status

user must have permission to request current part status information

subscriber 24 where the user is must have the proper business agreements to request current part status information.

5. current location

user must have permission to request current part location information

subscriber 24 where the user is must have the proper business agreements to request current part location information.

6. report

user must have permission to request reports

subscriber 24 where the user is must have the proper business agreements to request reports.

7. search

user must have permission to initiate the search

subscriber 24 where the user is must have the proper business agreements to initiate search

8. action

user must have permission to request a specific action

the console user is using must have the specific action enabled

part flags must resolve for the specific action

validation must resolve for the specific action

9. change status

user must have permission to request the specific status change

the console user is using must be enabled for the specific status change

part flags must resolve for the specific status change

validation must resolve for the specific status change

10. set flag

only as a consequence of authentication flag

only based on the current status flags and system information

set automatically by system only

11. log usage

user must have permission to change status

the console the user is using must be able to log usage

the part must be authentic

the part status must not be “scrapped”

12. log text notes

user must have permission to change status

the console the user is using must be able to log text notes

the part must be authentic

13. insert registration certificate

only as a consequence of register request

14. insert marking certificate

only as a consequence of mark request

15. request user registration information

the user must have permission to request user report

16. request user current status

user must have permission to request user report

17. request user current location

user must have permission to request user report

18. add new user

user must have permission to manage users

19. activate user

user must have permission to manage users

the user activated must be registered

the user activated must not be terminated

the user activated must be not active

20. deactivate user

user must have permission to manage users

the user deactivated must be registered

the user activated must not be terminated

the user activated must not be inactive

21. terminate user

user must have permission to manage users

the user deactivated must be registered

the user activated must not be terminated

22. set user permissions

user must have permission to manage users

the user whose permission is set must be registered

the user activated must not be terminated

The agreed upon business rules, such as those listed by way of example above, are stored in a database of system 20 and are queried and applied automatically by system 20 with each request if pertinent to the request then being made.

The following examples facilitate explanation of secure part tracking system 20 and the use thereof. While the examples may refer to utilizing the internet for some communication purposes it should be understood that a subscriber 24 and provider 22 may agree upon a fully integrated in house system 20 or one that is networked throughout that particular subscribers own facilities. Authentication and verification will still apply to such systems as an integral and important part of such systems.

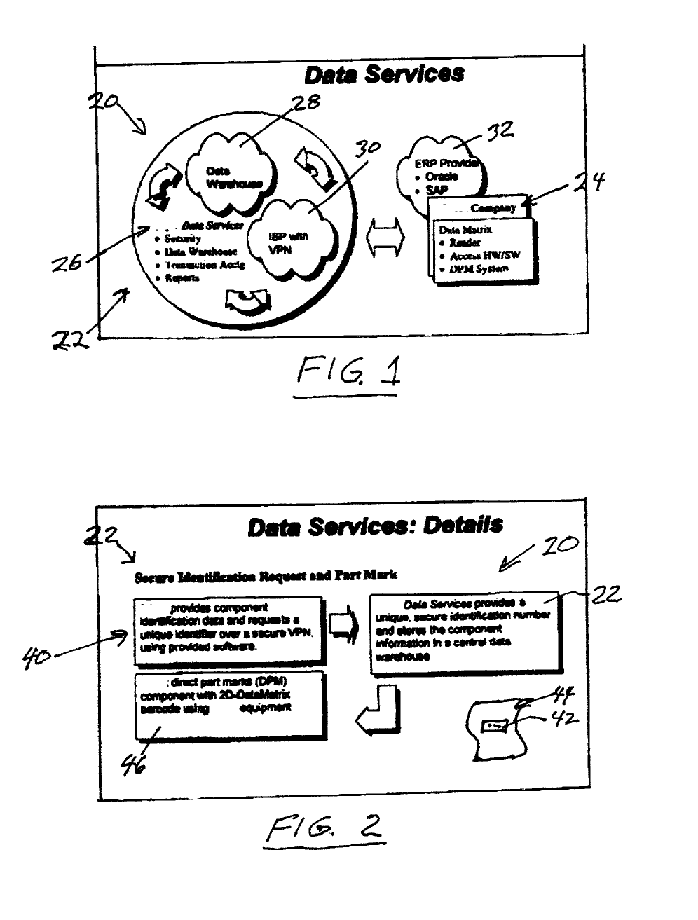

A manufacturer/subscriber 40 (FIG. 2) of parts to be tracked will only be able to obtain unique security codes for the parts being manufactured and to enter data that the part(s) have been so encoded and either shipped to a designated location or placed in inventory at the manufacturers location. If placed in inventory at the manufacturers location, the manufacturer will be able to re-enter tracking system 20 at a later date to modify the data to show that the parts from inventory have been shipped and the location such parts were shipped to.

Each part manufacturer/subscriber 40 (FIG. 2), whenever they require a unique part identifier 42 for a part 44 that has been manufactured, or is to be manufactured will log into system 20 through their internet service provider at which time the industry standard highest internet security protocols referred to above are initiated for each communication between subscriber 40 and system 20. If the manufacturer has a fully-integrated, in-house system 20 and does not require an internet service provider, then appropriate protocols are still utilized to insure that the party accessing system 20 and their server are authorized to use system 20 and to insure authentication and verification of the subscriber users and their computers and servers.

The trusted security component 32 (FIG. 1), described herein above, authenticates the appropriate system 20 server as well as the manufacturers server. The manufacturers server, in turn, authenticates the manufacturers computer and/or digital signatures. The person accessing system 20 is also authenticated through their user name and pass code combination, or otherwise as described above.

All data and information to be exchanged between manufacturer/subscriber 40 and system 20 is encrypted, also through conventionally available programs incorporated into system 20, or otherwise available to system 20.

Manufacturer/subscriber 40 (FIG. 2) transmits component identification data to system 20 and requests a different unique identifier 42 for each part 44 which may be transmitted over a secure virtual private network (VPN) using provided software. System 20 authenticates the manufacturer, decodes the encrypted request for unique identifier 42 and requests information that is necessary for further processing of the request from the database servers in the distributed database system. System 20, through the database servers, exchanges data with respect to the request in a manner that conforms to the aforementioned business rules.

System 20 takes all necessary actions, builds a reply message in a conventional document using the subscriber computer and browser type information to build a proper output document and streams that output to the manufacturer 40 thus providing manufacturer/subscriber 40 with a different unique identifier 42 for each part 44. System 20 also stores the component information in its central data warehouse 24 (FIG. 1). Manufacturer/subscriber 40 may thereafter proceed to mark each part 44 with its particular unique part identifier 42 utilizing appropriate and conventionally available encoded symbology such as a bar-code or a matrix type symbology such as a DATAMATRIX. To do so, the manufacturer/subscriber utilizes conventionally available symbology marking equipment 46 to place the encoded symbology for each unique part identifier 42 assigned to each part 44 upon an appropriate substrate that is secured to part 44 or the manufacturer may directly mark such encoded symbology upon part 44 through conventionally available direct part marking equipment and techniques. Each individual part 44 will thus carry its own unique part identifier encoded symbology 42.

System 20 subscriber/manufacturer 40 may also utilize such parts 44, each of which carries unique security code 42 as described herein above, for assembly into a sub-assembly, assembly or otherwise for incorporation into original or rebuilt or remanufactured equipment. Another subscriber/manufacturer 60 (FIG. 3), however, after receiving such parts 44 (FIG. 2) with unique security coding 42. Alternatively subscriber 60 (FIG. 3) may utilize parts 44 (FIG. 2) as replacement parts to line install in an aircraft or otherwise when performing routine maintenance on the aircraft or its equipment; or to rebuild the equipment that incorporates the part(s), or to rebuild, refurbish, or otherwise deal with the part.

In doing so such subscribers 40 (FIG. 2), 60 (FIG. 3) use a conventionally available code reader 62 at step 64 to capture the unique security code 42 (FIG. 2) from each part 44 so utilized. Thereafter the subscriber logs into system 20, as herein above described with respect to subscriber 40(FIG. 2), accesses those parts 44 so utilized by their respective unique security codes 42 and requests the appropriate active actions to be taken from a list of such actions similar to that of 2 b, I of the Sample List Of Requests herein above. When that is accomplished the status for each such utilized part 44 is set according to a listing such as that of 2 b, ii of said herein above Sample List Of Requests.

System 20, through data services component 26, at step 66 )FIG. 3) records the status against utilized parts 44 with their respective unique security codes 42 and informs all subscribers associated with such parts 44 of such information and latest activity. Such subscribers thereafter receive the updated data concerning such parts at step 68.

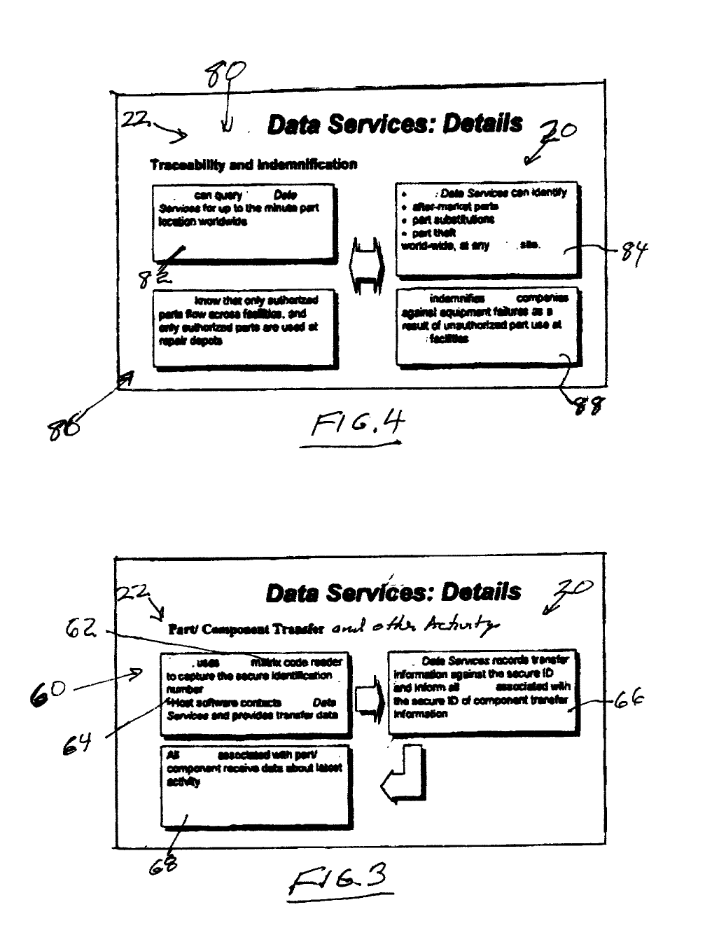

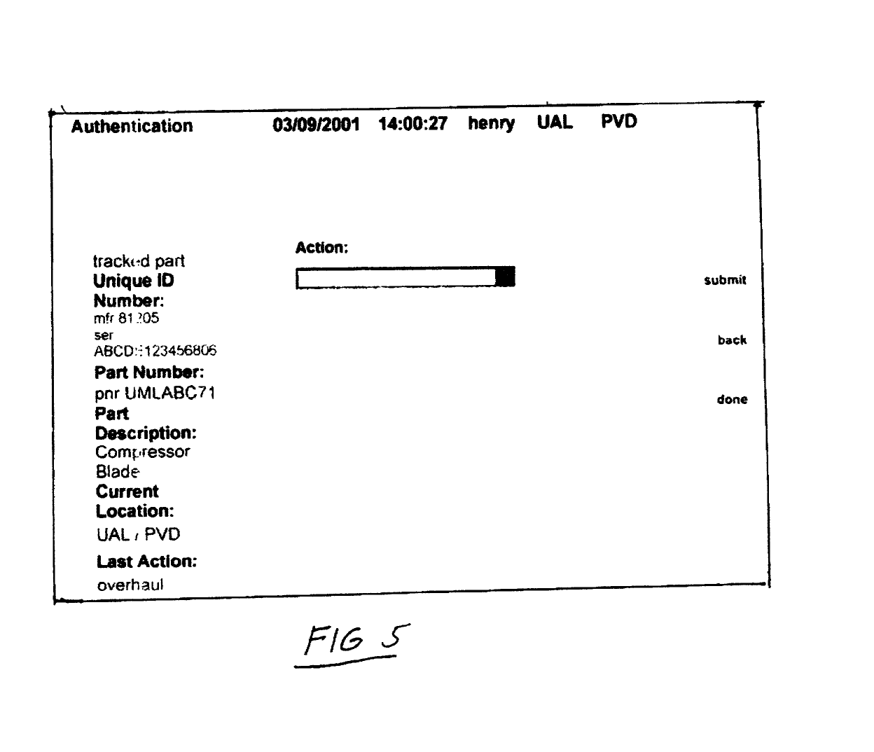

Either the same subscribers 40, 60 or another subscriber 80 (FIG. 4) can query system 20 concerning up to the minute part location worldwide, such as at step 82 after login as described herein above. Data services component 26, at step 84, is established and provided with appropriate communications and databases to provide information and data such as after-market parts, part substitutions, part theft, etc- worldwide at any site. The information and data to be so provided will depend upon the type and use of the articles so being tracked. All subscribes utilizing system 20 know, such as at step 86, that only authorized parts flow across facilities, and only authorized parts are used at repair depots. If desired provider 22 may, as at step 88 indemnify subscribers against equipment failures as a result of unauthorized part use at facilities.

A secure tracking system for jewelry and/or works of art might be arranged with components as described herein above or may be more easily accessed through an available conventional web browser attached to the internet. As described above such a tracking system could still include user and user equipment security through trusted third party authentication and verification as described herein above for other articles. Status, chronological history and availability data and information would be made available to subscribers. Such a system would preferably link certificates of authentication, issued by approved and trusted industry authorities, to the article with unique article id security codes for each such article. Information and data such as for tracking, shipping, receiving, selling and retrieving are but some of the types of information and data to be provided by this type of secure article tracking system.

From the above description it will thus be seen that there has been provided new and improved systems and methods for the secure, authenticated and verified tracking of articles, such as manufactured parts and components, jewelry, works of art and the like; including the correlation of those articles against available databases so as to provide not only a complete chronological history of the respective articles but also a chronological history of articles incorporating or utilizing such articles and/or otherwise associated therewith.

It is understood that although there has been shown and described preferred embodiments of the invention that various modifications may be made in the details thereof without departing from the spirit as comprehended by the following claims.

What is claimed is:

1. A secure article tracking system, comprising:
a. computer login means for permitting a user to login to the system;
b. secure database means for receiving the login to verify and authenticate the user and computer login means; and
c. security number database means for assigning a unique security number for each article to be tracked.

2. The secure tracking system of claim 1, wherein said computer login means includes at least a data input means and a server means,

3. The secure tracking system of claim 1 wherein said database means may include a plurality of sub and ancillary database means each associated to some or all of the others.

4. The secure tracking system of claim 1 wherein either said secure database means, or components thereof may be accessible through the intemet.

5. The tracking system of claim 1, wherein: said security database means develops and maintains a chronological history of each article being tracked from the creation of that article at least until it is destroyed.

6. The tracking system of claim 5 wherein said security database means is accessible upon request by specified users to update and retrieve data concerning said chronological histories.

7. The tracking system of claim 5 wherein said security database means also includes chronological histories concerning devices, mechanisms and the like, which include said articles to be tracked, and which are also accessible to specified users upon request.

8. The tracking system of claim 7 wherein said security database means in addition includes data and information concerning equipment that includes such devices, mechanisms and the like which, in turn, include said articles to be tracked and which are accessible to specified users upon request.

9. The tracking system of claim 8 wherein said data and information concerning equipment and said chronological histories concerning devices, mechanisms and the like may be obtained through ancillary databases that are searchable to the system.

10. The tracking and security system of claim 9 wherein said security database means includes business rules, data and information that are correlated to specified user requests such that only certain users can input, update and/or search only specified portions of said security database means.

11. The tracking and security system of claim 6 wherein said chronological histories may include data and information, for each article to be tracked, such as register, manufacture, mark, store, ship, receive, pack, unpack, install, remove, modify, repair, overhaul and/or scrap or any combination of same.

12. The tracking and security system of claim 11 wherein the articles to be tracked are parts, subassemblies, assemblies, devices or mechanisms, or combinations thereof.

13. The tracking and security system of claim 12 wherein such articles to be tracked are for use in aircraft.

14. The tracking and security system of claim 12 wherein such articles to be tracked are for automotive equipment.

15. The tracking and security system of claim 12 wherein such articles to be tracked are for use in military equipment.

16. The tracking and security system of claim 6 wherein said chronological histories are for items of jewelry and/or works of art and may be correlated to certificates of authentication for such items of jewelry and/or works of art and may further include data and information such as tracking, shipping, receiving, selling, retrieving fake or bogus or lost or stolen.

17. A secure article tracking system, comprising:
a. a computer login device for permitting a user to login to the system;
b. a secure database for receiving the login to verify and authenticate the user and computer login; and
c. a security number database for assigning a unique security number for each article to be tracked.

18. The secure tracking system of claim 17, wherein said computer login device includes at least a data input and a server,

19. The secure tracking system of claim 17 wherein said database may include a plurality of sub and ancillary databases each associated to some or all of the others.

20. The secure tracking system of claim 17 wherein either said secure database, or components thereof may be accessible through the internet.

21. The tracking system of claim 17, wherein: said security database develops and maintains a chronological history of each article being tracked from the creation of that article at least until it is destroyed.

22. The tracking system of claim 21 wherein said security database is accessible upon request by specified users to update and retrieve data concerning said chronological histories.

23. The tracking system of claim 21 wherein said security database also includes chronological histories concerning devices, mechanisms and the like, which include said articles to be tracked, and which are also accessible to specified users upon request.

24. The tracking system of claim 23 wherein said security database in addition includes data and information concerning equipment that includes such devices, mechanisms and the like which, in turn, include said articles to be tracked and which are accessible to specified users upon request.

25. The tracking system of claim 24 wherein said data and information concerning equipment and said chronological histories concerning devices, mechanisms and the like may be obtained through ancillary databases that are searchable to the system.

26. The tracking and security system of claim 25 wherein said security database includes business rules, data and information that are correlated to specified user requests such that only certain users can input, update and/or search only specified portions of said security database means.

27. The tracking and security system of claim 22 wherein said chronological histories may include data and information, for each article to be tracked, such as register, manufacture, mark, store, ship, receive, pack, unpack, install, remove, modify, repair, overhaul and/or scrap or any combination of same.

28. The tracking and security system of claim 27 wherein the articles to be tracked are parts, subassemblies, assemblies, devices or mechanisms, or combinations thereof.

29. The tracking and security system of claim 28 wherein such articles to be tracked are for use in aircraft.

30. The tracking and security system of claim 28 wherein such articles to be tracked are for automotive equipment.

31. The tracking and security system of claim 28 wherein such articles to be tracked are for use in military equipment.

32. The tracking and security system of claim 22 wherein said chronological histories are for items of jewelry and/or works of art and may be correlated to certificates of authentication for such items of jewelry and/or works of art and may further include data and information such as tracking, shipping, receiving, selling, retrieving fake or bogus or lost or stolen.

33. A method to securely track articles, comprising at least the steps of:
a. providing a secure article tracking system;
b. providing said system with at least a secure database;
c. logging into said secure database;
d. authenticating and verifying each such login; and
e. assigning a unique number for each article to be tracked.

34. The method of claim 33 including providing at least a data input device and a server for logging into said system.

35. The method of claim 34 including providing a plurality of sub and ancillary databases each associated to some or all of the others.

36. The method of claim 35 including accessing either said secure database means, or components thereof through the internet.

37. the method of claim 33 including utilizing said security database means to develop and maintain a chronological history of each article being tracked from the creation of that article at least until it is destroyed.

38. The method of claim 37 including accessing said security database by request of specified users to update and retrieve data concerning said chronological histories.

39. The method of claim 38 including inputting said security database means to also include chronological histories concerning devices, mechanisms and the like, which include said articles to be tracked, and which are also accessible to specified users upon request.

40. The method of claim 39 including obtaining said security database with data and information concerning equipment that includes such devices, mechanisms and the like which, in turn, include said articles to be tracked and which are accessible to specified users upon request.

41. The method of claim 40 including also providing said data and information concerning equipment and said chronological histories concerning devices, mechanisms and the like through ancillary databases that are searchable to the system.

42. The method of claim 41 including providing said security database with business rules, data and information that are correlated to specified user requests such that only certain users can input, update and/or search only specified portions of said security database.

43. The method of claim 38 including unputting said chronological histories with data and information, for each article to be tracked, such as register, manufacture, mark, store, ship, receive, pack, unpack, install, remove, modify, repair, overhaul and/or scrap or any combination of same.

44. The method of claim 43 wherein the articles to be tracked are parts, subassemblies, assemblies, devices or mechanisms, or combinations thereof.

45. The method of claim 44 wherein such articles to be tracked are for use in aircraft.

46. The method of claim 44 wherein such articles to be tracked are for automotive equipment.

47. The method of claim 44 wherein such articles to be tracked are for use in military equipment.

48. The method of claim 38 including inputting said chronological histories with data and information for items of jewelry and/or works of art and may be correlated to certificates of authentication for such items of jewelry and/or works of art and further inputting data and information such as tracking, shipping, receiving, selling, retrieving fake or bogus or lost or stolen.
